(19) United States
(12) Patent Application Publication
(10) Pub. No.: US 2004/0042039 A1
(43) Pub. Date: Mar. 4, 2004

(54) Image forming apparatus and circuit board

(75) Inventors: Nobuyuki Kodera, Kanagawa (JP); Tsuyoshi Yaguchi, Kanagawa (JP); Keiji Yamanaga, Kanagawa (JP); Wataru Minami, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 10/389,817

(22) Filed: Mar. 18, 2003

(30) Foreign Application Priority Data
Aug. 29, 2002 (JP) 2002-250588

(51) Int. Cl. G06F 3/12; G06F 11/30; G06F 13/00

(52) U.S. Cl. 358/1.15; 399/9; 358/504

(57) ABSTRACT

An image forming apparatus is divided into detachable modules such as an IOT module and an EXIT module. A circuit architecture is constructed in which a main module circuit containing a master control part for controlling the whole system and a plurality of sub-module circuits containing slave control parts controlled by the master control part are separately handled according to the respective functional parts in the apparatus. Each module circuit includes a CPU on which a common operating system is installed, and an I/O part which interfaces with functional operation parts which operate corresponding to the dedicated functional parts. The CPU and the I/O part are mounted on daughter boards, which are removably attached to a mother board. A circuit-attribute select controller part 150 selects a main module circuit or sub-module circuits.

### BACKGROUND OF THE INVENTION

1. Field of the Invention

The present invention relates to an image forming apparatus with a printing function and circuit boards.

2. Description of the Related Art

An image forming apparatus having a printing function, such as a printer or a copying machine, is used in various fields. Nowdays, the image forming apparatus is colorized, and comes to be used as various expression means by users. For example, a color page printer based on the electrophotographic (xerographic) process attracts attention in that it has excellent features of higher picture quality or high speed printing.

From the point of view of the printing function, the image forming apparatus may be categorized into an image forming apparatus of a type which needs the capability of outputting a relatively small number of prints (for example, several to several tens of prints per job) and is for personal use in the home or for business use in offices, and an image forming apparatus of a type which needs the capability of outputting a relatively large number of prints (for example, several thousands of prints per job), and is used in printing business, such as bookbinding. In the case of the former type of image forming apparatus which needs the capability of outputting a relatively small number of prints, the apparatus receives print data and outputs a print without generating a block copy in most cases (except the stencil printing). In the case of the latter type of image forming apparatus which needs the capability of outputting a relatively large number of prints, the apparatus by convention prepares a block copy and outputs a print by use of the prepared block copy.

Meanwhile, nowdays, the DTP (desk top publishing/prepress) is widely used, and the printing process has greatly been changed, viz., called “digital revolution of printing” has progressed. In this situation, attraction is focused on “direct printing or “on-demand printing” (referred representatively to as “on-demand printing”). The on-demand printing employs a printing system (CTP: computer to print or paper). In the CTP, the pre-press process is completely digitized, and prints are output in accordance with only electronic data without generating intermediate products, such as print (photographic paper), block copy, dot positive film, dot negative film, and PS plate, in the phototype setting in the conventional printing (e.g., offset printing). In connection with the need of the on-demand printing, a printing function based the xerography process attracts attention.

FIG. 9 is a diagram showing an outline of an image forming system containing a conventional image forming apparatus.

The image forming system contains an image forming apparatus land a DFE (digital front end processor) as a terminal device which transfer sprint data to the image forming apparatus 1 and instructs it to print.

The image forming apparatus 1 records an image on a predetermined recording medium by the utilization of the xerography process. The apparatus is made up of an IOT (image output terminal) module 2, a feeder (sheet feeder) module (FM) 5, an EXIT module 7, a user interface unit 8, and a coupling module 9 for coupling the IOT module 2 with the feeder module 5.

The DFE has a printer controller function. The DFE receives, from a client terminal, print data described in the page description language (PDL) which is capable of controlling enlargement, rotation, modification and the like of graphic, characters and others; it converts the print data into raster image (raster image process (RIP)); it sends the RIP processed image data and print control information (job ticket), such as the number of printed sheets of paper and sheet size, to the image forming apparatus 1; and it controls a print engine and a sheet transporting system in the image forming apparatus 1 to cause the image forming apparatus 1 to execute a print process. Thus, the printing operation of the image forming apparatus 1 is controlled by using the printer controller function of the DFE.

In this case, the print data contains a total of four color components of three colors of yellow (Y), cyan (C) and magenta (M) as the fundamental colors for color printing, and one color of black (K) (those colors will be referred generally to as YMCK). Such print data is sent to the image forming apparatus 1.

The user interface 8 assists the user in his plain interactive communication with the image forming apparatus 1. To improve the operability of such operations, the user interface is provided with a color display 8a combined with a touch panel and a hard control panel 8b located on the side of it, and as shown, is mounted on a base machine (apparatus body: coupling module 9 in this instance) in a state that a support arm 8c is raised.

The IOT module 2 includes an IOT core part 20 and a toner supplying part 22. Toner cartridges 24 containing color toners of YMCK colors for color printing are mounted on the cylindrical connection pipes 24.

The IOT core part 20 includes print engines (print units) 30 provided for each color component. Each of the print engines includes an optical scanner 31 and a photo sensitive drum 32. The IOT core part 20 has a called tandem construction in which the print engines 30 are arrayed in a row in the sheet transporting direction. The IOT core part 20 contains an electric system control container 39 for containing electric circuitries for controlling the print engines 30 or power source circuits for modules.

The IOT core part 20 employs an image transfer system in which the toner images are (primarily) transferred from the photo sensitive drums 32 onto an intermediate transfer belt 43 by a primary transfer unit 35, and thereafter the toner image is (secondarily) transferred from the intermediate transfer belt 43 onto a printing sheet by a secondary transfer unit 45. In the thus constructed IOT core part, images are respectively formed on the photo sensitive drums 32 by use of color toners of YMCK colors, the toner images are multiple transferred onto the intermediate transfer belt 43, and thereafter the composite toner image is transferred onto a predetermined printing sheet, whereby a color image is reproduced.

In each print engine 30, to start with, the related optical scanner 31 scans a surf ace of the related charged photo sensitive drum 32 by laser light modulated by image information to thereby form an electrostatic latent image on the photo sensitive drum 32. The latent images thus formed are visualized into toner images by developing units 34 to which toners of YMCK colors are supplied, and the toner images are transferred onto the intermediate transfer belt 43 by the primary transfer unit 35.

In the feeder module 5, a printing sheet is picked up from a paper tray 52 in link to the image transferring to the intermediate transfer belt 43, and is fed to a first transport path 47 of the IOT module 2. The first transport path 47, which has a positioning/aligning function (Regi/Aligner), registers and aligns a writing position of the printing sheet, and transports it to the secondary transfer unit 45.

The image (toner image) having been transferred onto the intermediate transfer belt 43 is transferred onto a printing sheet coming from the feeder module 5 at a predetermined timing, and transported to a fuser 70 along a second transporting path 48, and the toner image is fused and fixed on the printing sheet by the fuser 70. Thereafter, the printing sheet bearing the fixed image is temporarily stored in a stacker (discharge tray) 74 or directly transported to a discharged sheet processor 72. If necessity arises, it is subjected to a predetermined finishing process, and then discharged out of the machine. To the both-side printing, the printed printing sheet is picked up from the stacker 74 and fed to a reversing path 76, and transferred to a reverse transporting path 49 of the IOT module 2.

FIG. 10 is a block diagram showing a configuration of a circuit module of the FIG. 9 image forming apparatus 1. As shown, the cover member includes a circuit module for the IOT core part 20 and a circuit module for the feeder module 5. The circuit module for the IOT core part 20 is contained in the electric system control container 39, and the circuit module for the feeder module 5 is contained in the feeder module 5.

The circuit module for the IOT core part 20 includes a marking part MK as a major part in the image formation, a feed control part PH concerning the sheet transportation, a fuser part FU concerning the control of the fuser 70, a discharge part EX concerning the discharging of printed sheet from the machine, an IOT control part CT for controlling the respective parts in the IOT core part 20, and a power source circuit PW for supplying electric power to those parts.

Those parts are mounted on a PWB (circuit board), and are connected to the IOT control part CT through driver circuits. The circuit module for the IOT core part 20 is connected to the user interface 8 through an I/F control part.

And now, at present, there is a need of further increasing image (print) processing speed and its performance level, and making it multi-functional. The printer controller of the DFE contains high speed/high performance CPUs, and accordingly, is capable of generating data at high speed which enables the speed of the print engines to be fully utilized. A high speed full color printing system is proposed which supports a total productivity over a range from the print instruction to the print output, and is capable of performing the full color printing at printing speed of 100 to 200 sheets per minute or higher.

To meet the needs of the high speed, high performance and others, it is necessary not only to so design the DFE but also to design the carriage 1 so as to have high speed, high performance and multi-functions. Specifically, the image forming apparatus of a 4-plate tandem type using colorants of four colors is modified into image forming apparatus of a 5 (or larger) plate tandem type which uses colorants of five or larger colors, or the image forming apparatus is modified to have a high speed specification of 100 to 200 sheets per minute or higher. Additionally, there is a need that one image forming apparatus is selectively used in one of multiple operation modes according to a required specification.

However, the conventional image forming apparatus 1 comes to incapacitate satisfaction of such needs it becomes difficult for the conventional image forming apparatus 1 to satisfy such needs. For example, as described above, the most parts of the circuitry forming the image forming apparatus 1 is contained in the circuit module for the IOT core part 20, and the processing/controlling mechanism is constructed with almost one unit.

Whenever the need of changing the circuit arises in order to achieve the high speed, high performance and multi-functions of the system, it is necessary to replace the whole circuit module for the JOT core part 20 with another circuit module or to change the design of the circuit module board PWB even if what is to be changed is a part of the circuit. This results in further increase of cost to manufacture.

### SUMMARY OF THE INVENTION

Accordingly, an object of the present invention is to provide an image forming apparatus and circuit boards, which are capable of flexibly achieving high speed, high performance or multi-functions of the system.

According to a broad aspect of the invention, there is provided a first image forming apparatus for forming an image on a predetermined recording medium according to input image data and outputting the formed image, wherein an image forming part for transferring the image onto a predetermined recording medium and a fuser part for fixing the transferred image on the recording medium are removably put in different housings, respectively.

According to another broad aspect of the invention, there is provided a second image forming apparatus which forms an image on a predetermined recording medium according to input image data, the image forming apparatus includes a plurality of functional module circuits corresponding to functional parts of the image forming apparatus.

In the second image forming apparatus, one of the functional module circuits includes a main module circuit containing a master control part for controlling individual circuits of the image forming apparatus, and the other of the functional module circuits includes sub-module circuits containing slave control parts which operated according to an instruction by the master control part. In other words, the main module circuit containing a master control part and the sub-module circuits containing slave control parts are separately handled.

A relation of the master control to the slave control part is relative, and not fixed. For example, the slave control part operating under control of a first master control part serves as a second master control part to another control part, and controls operations of the another control part.

In the second image forming apparatus, the respective module circuits are controlled preferably by a substantially common software architecture.

Many other embodiments of the image forming apparatus of the invention are defined in the appended claims.

In the first image forming apparatus, the image forming part including an image transfer mechanism and a fuser part for fusing and fixing the transferred image on the recording medium are removably put in different housings, respectively. Accordingly, when only the image forming part must be changed, only the image forming part is replaced with another one. When only the fuser part must be changed, only the fuser part is replaced with another one. In this way, the high speed, high performance or multi-functions of the system can be achieved by merely changing either of them.

A circuit architecture containing a plurality of functional module circuits corresponding to the functional parts in the image forming apparatus is used. A main module circuit including a master control part and a plurality of sub-module circuits each including a slave control part are separately handled. To achieve the high speed, high performance or multi-functions, a necessary module circuit is replaced with another one.

### BRIEF DESCRIPTION OF THE DRAWINGS

FIGS. 1A and 1B are diagrams showing an image forming system equipped with an image forming apparatus which is an embodiment of the invention.

FIG. 2 is a diagram showing an overall configuration of the image forming apparatus of the invention.

FIGS. 3A and 3B are diagrams showing a configuration of a circuit module of the image forming apparatus shown in FIG. 2.

FIG. 4 is a diagram showing a specific configuration of an image forming apparatus 1 into which the technical scheme of FIGS. 2 and 3 is incorporated.

FIG. 5 is a diagram showing a connection configuration of a circuit module, which is depicted in light of a physical interface.

FIG. 6 is a diagram showing a connection configuration of a circuit module, which is depicted in light of a logic interface.

FIG. 7 is a diagram showing a configuration of a specific board interface when the connection configurations shown in FIGS. 4 to 6 are applied to the FIG. 2 image forming apparatus.

FIGS. 8A and 8B are diagrams for explaining another configuration of the board interface.

FIG. 9 is a diagram showing an outline of an image forming system containing a conventional image forming apparatus.

FIG. 10 is a block diagram showing a configuration of a circuit module of the FIG. 9 image forming apparatus.

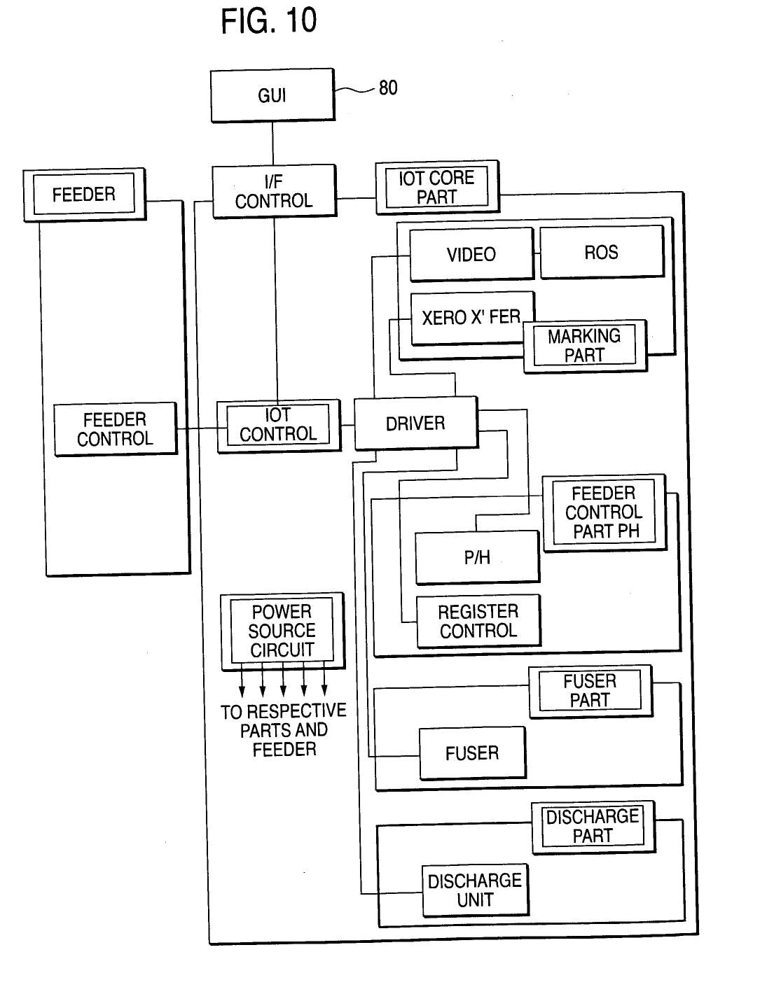

### DETAILED DESCRIPTION OF THE PREFERRED EMBODIMENTS

Preferred embodiments of the present invention will be described in detail with reference to the accompanying drawings.

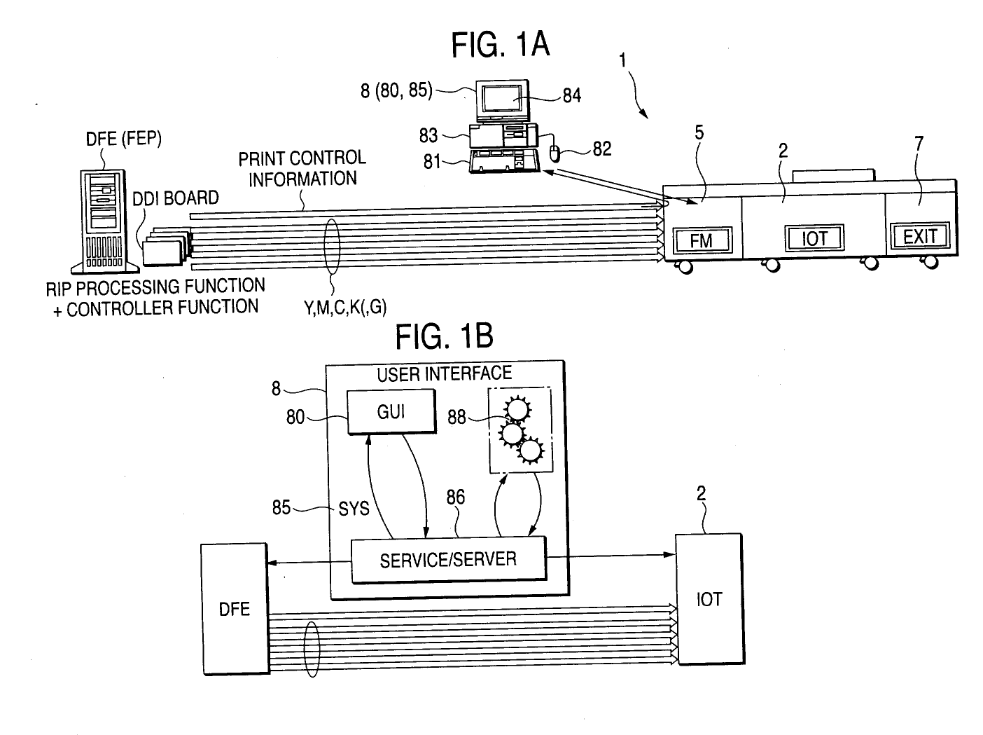

FIGS. 1A and 1B are diagrams showing an image forming system equipped with an image forming apparatus which is an embodiment of the invention. FIG. 1A shows a system configuration and FIG. 1B shows an exemplar connection in connection with the detail of a user interface.

The image forming system contains an image forming apparatus 1 and a DFE as a terminal device which transfers print data to the image forming apparatus 1 and instructs it to print.

The image forming apparatus 1 records an image on a predetermined recording medium by the utilization of the xerography process. In the instant image forming apparatus, the fuser is provided in an output (EXIT) module 7, while it is provided in the IOT module 2 in the conventional image forming apparatus.

Specifically, the image forming apparatus 1 in the image forming system is made up of an IOT (IOT body) module 2, a feeder (sheet feeder) module (FM) 5, an output module 7, and a user interface 8, such as a personal computer (PC). The feeder module 5 maybe of the multi-stage type. A coupling module for coupling those modules may be used, if necessary.

A finisher (=post processor) module may be-connected to the output of the EXIT module 7, if necessary. The finisher modules applies a predetermined finishing process to the printed sheet having an image, which is formed by the IOT module 2.

An example of the finisher module contains a stapler which stacks printing sheets and staples the stacked sheets together at one position of the corner or at two positions on one of the sides of the stacked sheets or another example of the finisher module contains a punching mechanism for punching the stacked sheets to form punched holes used for filing. It is desirable that the finisher module may be used in an off-line state that it is disconnected from the user interface 8.

The image forming apparatus 1 is constructed such that the modules of the apparatus may be replaced with other ones for each module. In particular, in the image forming apparatus 1, the IOT module 2 and the EXIT module 7 are separate modules. Accordingly, in a case where a measure is taken to achieve the high speed, high performance and multi-functions of the system, and those may be achieved by changing only either of the fuser 70 and the print engines 30 as a major part of the image forming portion, what the user has to do is to merely replace only the corresponding one with another one.

The DFE includes an FEP (front end processor). The DFE and the image forming apparatus 1 are coupled to each other through a DDI (direct digital interface) as an interface specially designed. The FEP has a function to convert data received from a client into raster data by a ROP (raster operation) process (RIP process), and compress the raster image as converted. Further, it has a printer controller function for executing the print control based on the image forming apparatus 1. An interface DDI board which interfaces with the image forming apparatus 1 is mounted on the DFE. The ROP processor, the printer controller and others are mounted on the DDI board.

The RIP process and the compression process are designed so as to be compatible with the high speed processing of the carriage motor 2. The printer controller associated with the DFE contains high speed/high performance CPUs. Accordingly, the printer controller is cable of performing high speed full color printing since it enables high speed data generation which allows the speed of the print engine to be fully utilized, and supports a total productivity over a range from the print instruction to the print output. The printer controller enables a system which can handle high speed color printing at 100 sheet per minute.

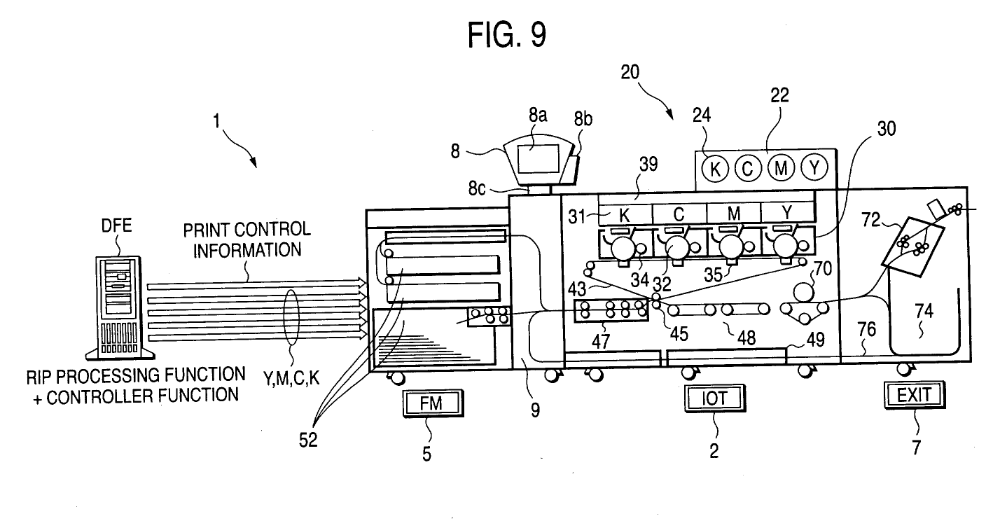

The user interface 8 includes input devices, such as a keyboard 81 and a computer mouse 82. The user interface includes a GUI (graphic user interface) 80 which presents an image to the user on a screen of a CRT 84 and accepts instructions from the user. The user interface further includes in its main body 83 a Sys (system control) part 85 having an interface function between the DFE and the respective modules of the image forming apparatus 1, and a control function. The main body 83 contains boards for the user interface 8, such as a monitor control/power source board 894 or an engine board 895 in the conventional apparatus shown in FIG. 9.

In the image forming apparatus under discussion, unlike the conventional apparatus shown in FIG. 9, the user interface 8 is directly mounted on the apparatus body (coupling module 9 in this instance). The functions of the soft buttons provided by the utilization of a touch panel and the hard control panel 8b in the conventional apparatus are substituted by the keyboard 81 and the computer mouse 82. Also in the embodiment, a touch panel may be combined with the screen of the user interface 8, as a matter of course.

The user interface 8 contains a control software for operating the image forming apparatus 1. The user interface 8 is connected to the DFE having the image processing function. The user interface 8 receives RIP processed print data and print control information, such as the number of printed sheets and sheet size, and causes the image forming apparatus 1 to execute a print process as requested.

The print data contains data of a total of four colors (YMCK); three colors of yellow (Y), cyan (C) and magenta (M) as the fundamental colors for color printing, and one color of black (K). A fifth color component of, for example, gray (G), may be used in addition to the four colors.

The control software of the user interface 8 receives print control information (print commands) from the DFE through the interface part of the image forming apparatus, and controls a printing operation of the image forming apparatus 1 by the Sys part, under control of the DFE. In a case where a plurality of printed sheets are output, for example, when the collation is set, and a case where after a print is output, the user wants another print, and the reprinting is performed, prints may be efficiently outputted at high speeds by utilizing the RIP processed data stored in the DFE.

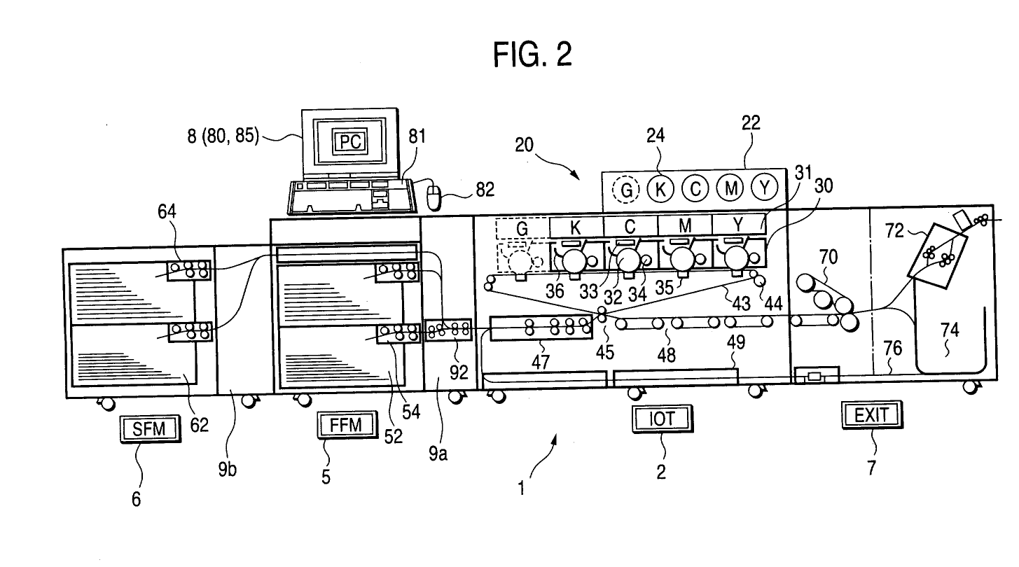

FIG. 2 is a diagram showing an overall configuration of the image forming apparatus of the invention. The image forming apparatus 1 includes an IOT module 2, a first feeder (sheet feed) module (FFM: first feeder module) 5, a second feeder module (SFM: second feeder module) 6, an EXIT module 7, and an user interface 8.

The IOT module 2 and the first feeder module 5 are intercoupled by a first coupling module 9a, and the feeder module 5 and the second feeder module 6 are intercoupled by a second coupling module 9b. The IOT module 2 is directly coupled to the EXIT module 7.

In a case where the high performance and high speed are required for the image forming apparatus, and the print engines are arranged to be adaptable for the printing of five or more colors, the fuser unit is also complicated in construction and large in size. Therefore, it is difficult to assemble the print engines and the fuser part into one and the same IOT module.

To cope with this, in the image forming apparatus 1 of the instant embodiment, the IOT module 2, the two feeder modules 5 and 6, and the EXIT module 7 are formed in separate units, respectively. With this, even if the sheet feeder parts 5 and 6, and the fuser part are changed, a change of the IOT body (IOT module 2) is minimized to thereby improve the system expansion. If required, the EXIT module 7 maybe further divided into a fuser module and a sheet discharge module as indicated by a one-dot chain line located at the central part of the EXIT module.

Pickup roller groups (designated by reference numerals 54 and 56) for picking up printing sheets from the paper trays (designated by reference numerals 52 and 62) are provided on the feeder module 5 and the second feeder module 6. The first coupling module 9a includes a transporting roller group 92 for transferring printing sheets coming from the feeder module 5 and the second feeder module 6 to the transporting path of the TOT module 2.

The EXIT module 7 includes a fuser 70 for fusing and fixing an image having been transferred to a printing sheet by the TOT module 2, a discharged sheet processor 72 for discharging the printing sheet having an image having been transferred thereonto, a discharge tray 74 for temporarily storing the printed sheet without discharging it to the machine outside, and a reversing path 76 for returning the printed sheet to the TOT module 2 in an inverted state. The fuser 70 is specified so as to be adaptable for the high speed processing of the TOT module 2.

The discharged sheet processor 72 may have a finisher function, such as a simple stapler process. The discharged sheet processor 72 is operable in an off line state that it is disconnected from the user interface 8.

The TOT module 2 includes an TOT core part 20 and a toner supplying part 22. The toner cartridges 24 of YMCK colors for color printing are mounted, as a standard set, on the toner supplying part 22. A toner cartridge 24 containing toner of gray G as a fifth color component maybe mounted on to the toner supplying part, in addition to the four color toners.

The IOT core part 20 is of the tandem type in which the print engines (print units) 30, which are respectively provided for color components, are arrayed in a row in the sheet transporting direction. Toners (colored powdery materials) as developing materials are supplied to the developing units 34 of the print engines 30 via supplying paths (e.g., reserve tanks), not shown, from the toner cartridges 24.

The print engines 30, provided respectively for the colorant colors, are arrayed in an order determined in consideration of relationship between dark decay and each toner characteristic, and different influences of color toners other than the black toner upon the black toner when those color toners are mixed (the illustrated order of the print engines arrayed is given by way of example).

The toner cartridges 24 and the photo sensitive drums 32 are detachably attached to the apparatus body. To take a more strict countermeasure against the fraudulent article than in the conventional apparatus, the apparatus body and the toner cartridges 24 and the like are detachably connected for the transferring of electrical signals therebetween. To this end, the optical transmission technique using optical members for transmitting/receiving laser light or infrared rays of light, is employed.

Generally, it is harder to obtain the optical transmission parts than the circuit parts using radio waves, and the prices of the former are higher than that of the latter. The mounting of those optical transmission parts will be more difficult than in the measure taken against fraudulent articles using radio waves (see U.S. Pat. No. 6,181,885, for example). Such a tendency is more remarkable particularly, in the optical components using laser light, such as semiconductor laser devices.

Accordingly, the measure taken against fraudulent articles is more reliable than the measure using radio waves. Since the detachable connection is used for the signal transfer, the mounting work of the cartridges 24 and the like is easy. The radio-wave basis measure taken against fraudulent articles will create problems of EMI (electromagnetic interference) and EME (electromagnetic emission). The measure based on the optical transmission technique is free from such problems, however.

The IOT core part 20 includes an intermediate transfer belt 43, a secondary transfer unit 45, a first transport path 47 which transports the printing sheet to the secondary transfer unit 45 and has a positioning/aligning function (Regi/Aligner), a second transporting path 48 for transporting to the EXIT module 7 the printed sheet having has passed through the secondary transfer unit 45, and a reverse transporting path 49 for transporting to a transporting path 50 the one-side printed sheet inverted by the EXIT module 7. The first transport path 47 has the positioning/aligning function (Regi/Aligner).

A cleaner 44 for removing (cleaning) the image transferred onto the intermediate transfer belt 43 is disposed at a position (right side of the yellow print engine 30 in the drawing) near one of the tandem arrayed print engines 30, which is located most upstream as viewed in the belt transporting direction and above the intermediate transfer belt 43.

The IOT core part 20 is specified to provide high speed printing; it is equipped with a motor which is operable at a higher speed than the motor used in the conventional image forming apparatus 1. Further, the IOT core part 20 is specified to be of the high speed drive type by using a clock signal at high frequency.

The print engines 30 are print engines (marking engines) each based on the ROS (raster output scanner) which includes the optical scanners 31, photo sensitive drums 32 and various parts for xerography process, like the print engines used as print functional parts of printer, copying machines and the like. The print engines 30 have each high speed drive specifications, which are adaptable for high speed operating circuits.

Each optical scanner 31 reflects and deflects laser light (laser beam) emitted from a semiconductor laser device, not shown, by a polygonal mirror (rotary polygon mirror), not shown, toward the photo-receptor drums 32 as an example of a photosensitive body, and focuses laser light modulated by image information on a surface area to be scanned on the photo-receptor drum 32, by use of a lens group, not shown.

To form an image, the photo-receptor drums 32, which is rotated at a constant speed, are first charged by a voltage having predetermined polarities and amplitude. Printing sheets are picked up sheet by sheet from the paper tray 52 (62) by a pickup roller group 54 (64) at a predetermined timing, and fed to the secondary transfer unit 45 through the first coupling module 9a and the first transport path 47.

The leading end of the printing sheet is detected by a leading-end detector (not shown). In turn, laser light that is modulated by image signals (e.g., 8 bits for each pixel and each color component) by the optical scanner 31, is emitted from a semiconductor laser device toward the polygon mirror, which is driven by a scanner motor. Then, the laser light is reflected by the polygon mirror and led to the photo-receptor drum 32 through a lens group, and scans the surface of the photo-receptor drum 32.

A signal derived from the leading-end detector is output as a vertical sync signal to the record controller (not shown) for controlling the optical scanners 31. A main-scan detector detects laser light, and outputs a beam detect signal, which is to be a horizontal sync signal, to the record controller. The image signals are successively sent to the semiconductor laser in synchronism with the beam detect signal.

The laser beam that is reflected and deflected by the polygon mirror of the optical scanner 31 scans the surface of the photo-receptor drum 23 that is charged by a primary charger 33, through a lens group. Through the scanning operation, the image or background portion is selectively exposed to the laser light, so that an electrostatic latent image on the photo-receptor drum 32.

The latent images are developed into visual images as toner images by the developing units 34 supplied with color tones of YMCK or G colors. The toner images are successively multiple attracted and transferred onto the intermediate transfer belt 43 by the primary transfer unit 35. After the primary transferring, the toner left on the photo-receptor drums 32 is removed and collected from the surface of the photo-receptor drums 32, by the cleaner 36.

The image (toner image) that is transferred onto the intermediate transfer belt 43, then, is transferred onto the printing sheet having been transferred through a route from the feeder module 5, the second feeder module 6 to the first coupling module 9a, and is transferred to the EXIT module 7 through the second transporting path 48. And, the toner image is fused and fixed on the printing sheet by the fuser 70 of the EXIT module 7. Thereafter, the printed sheet is temporarily stored in the discharge tray 74 or directly transferred to the discharged sheet processor 72. And, if necessary, it is subjected to a predetermined finishing process, and discharged to outside the machine. In the both-side printing mode, the printed sheet is picked up from the discharge tray 74 and fed to the reversing path 76, and then transferred to the reverse transporting path 49 of the IOT module 2.

The IOT core part 20 shown in FIG. 2 employs an IBT (intermediate belt transfer) system of a one-belt type, which uses one belt. Another IBT system of a two-belt type which uses two belts may be employed instead. If necessary, the toner image may be directly transferred from the photo-receptor drums 32 onto the printing sheet, not using the intermediate transfer belt.

Where the IBT system is used, merits and demerits of the one belt type and the two belt type must be taken into consideration, in design. The IBT system of the one belt type is advantageous in that the belt drive control is easy or image quantity is less deteriorated. Typical disadvantages of it are: the belt is long (e.g., about 4 m); much manual work is needed for its replacement (e.g., needs two workers for its work); the maximum unit width is large (e.g., about 2 m) and hence, carry-in and -out work is inefficient; and the belt must has a module rigidity of a certain level.

Advantages of the two belt type are: the belt length is short (e.g., about 2 m) and its replacement is easy; it is relatively easy to design it for high speed operation and its system expansion (speed increasing degree) is good; and the maximum unit width is small (e.g., about 1 m). Disadvantages of it are: the image quantity is possibly deteriorated; alignment control for the two belts is needed; apparatus height (M/C height) is large (e.g., 1 m or longer); and two belts are needed to increase the running cost.

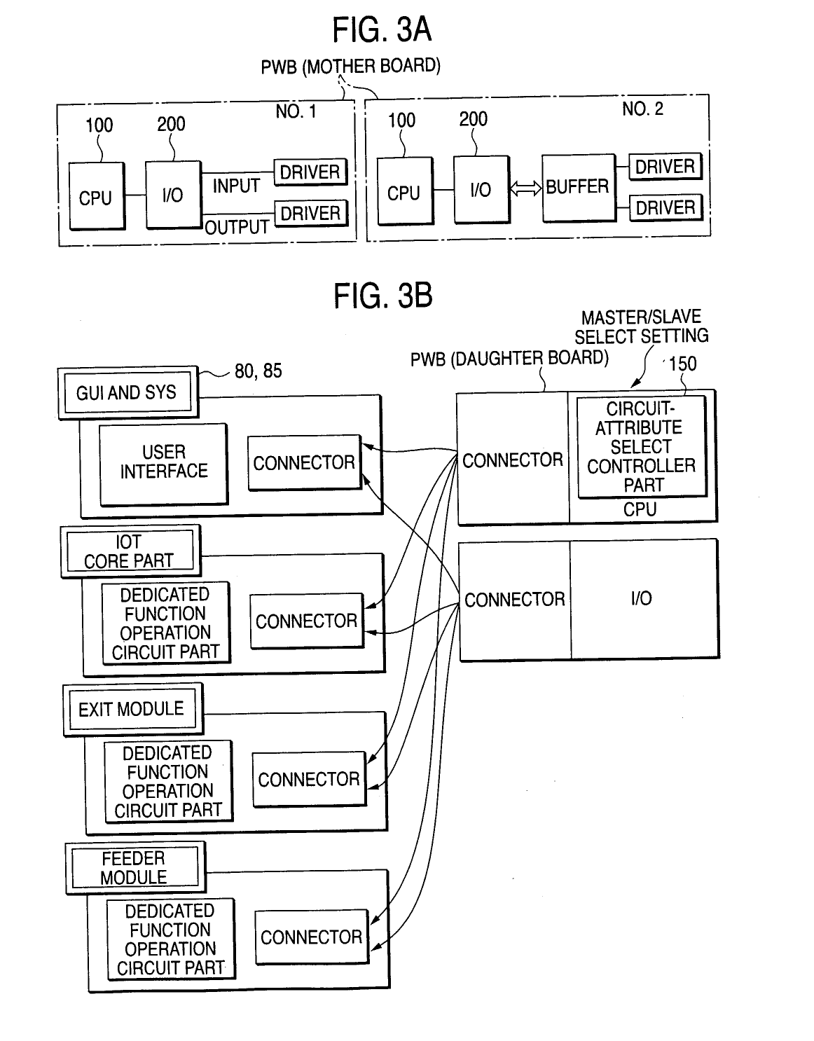

FIGS. 3A and 3B are diagrams showing a configuration of a circuit module of the FIG. 2 image forming apparatus. FIG. 3A is an explanatory diagram for explaining a major part of the circuit module. FIG. 3B is an explanatory diagram for explaining a relation among the respective circuit boards for the circuit module.

In the image forming apparatus 1 of the instant embodiment, as described in connection with FIG. 2, the respective modules are formed in separate units. Accordingly, even if the modules around the IOT body (IOT module 2), such as the feeder module and the fuser, are changed, a change of the IOT body is minimized to thereby improve the system expansion. In connection with this, a circuit architecture is employed which includes a plurality of function modules corresponding to the functional parts in the apparatus, and a main module containing a master control part and a plurality of sub-module circuits containing slave control parts are separately handled. To realize the high speed, high performance or multi-functions of the system, what one has to do is to merely replace only the required module with another module. Accordingly, the system expansion of the system is improved.

With the feature that the main module containing a master control part and the plurality of sub-module circuits containing slave control parts are separately handled. Accordingly, the controls of the functional parts in each circuit module board may be unified in their handling. In other words, the control system may be frameworked in accordance with the board module division.

For example, firstly, as shown in FIG. 3A, each circuit board PWB contains a CPU (central processing unit) 100 and an I/O part 200. The CPU 100 has a major information processing function and an arithmetic operation function in the individual parts on the board. The I/O part 200 serves as an input/output interface for driving functional operation parts (referred to as devices), which operate corresponding to the dedicated functional parts of the modules, such as circuit parts and motors in the modules. The circuit module is designed with the CPU 100 and the I/O part 200 as minimum constituent elements.

The CPU 100 is constructed with a logic circuitry (hardware logic circuitry) whose process contents may be updated by a software, such as FPGA (field programmable gate array) or DSP (digital signal processor). A volatile semiconductor memory, such as RAM (random access memory), ROM (read only memory) or a memory controller are disposed as its peripheral parts. Accordingly, the print process and the input/output process in the image forming apparatus 1 are re-programmable. Therefore, one can flexibly deal with debugging of the software. Further, even when to change the specifications for achieving the high speed, high performance and multi-functions of the system, it is connected to an IOT module different from that of an anticipated image forming apparatus 1, one can flexibly cope with such a situation.

The CPU 100 mounted on each board can control other circuits under control of a common OS (operating system), and functions as an operating system part into which a software architecture substantially common in connection with other circuit boards is incorporated. The I/O part 200 can control device drivers for driving the devices corresponding to the module dedicated functional parts under control of a common OS.

The term “common OS” does not mean software architectures which are completely identical with each other, inclusive of their versions, but embraces such software architectures that are somewhat different from each other, but are compatible with each other, and hence may be considered to be substantially the same.

Either of two connection configurations may selectively be used for connecting the CPU 100 and the I/O part 200 to the devices. A first connection configuration is shown in FIG. 3A, and denoted as “No. 1”. In this configuration, the CPU is connected to the input device or the output device through the I/O part 200. A second connection configuration is denoted as “No. 2” in the same figure. In the connection configuration, a buffer is interposed between the I/O part 200 and the devices. Either of the connection configurations allows the CPU and the I/O part to be connected to two or more devices systems. Additionally, a master/slave relation of the devices of two or more device systems may be set as desired.

The CPU 100 and the I/O part 200 as minimum constituent elements in the circuit module are mounted on a sub-circuit board (referred also to as a daughter board), which is mounted on a mother board dedicatedly used for each module. In this case, the CPU 100 and the I/O part 200 may be mounted on the same daughter board or respectively on different daughter boards.

A circuit-attribute select controller part 150 for selecting a main module circuit or sub-module circuits is provided on each daughter board. With provision of the circuit-attribute select controller part, a master/slave relation of the CPU 100 (i.e., the daughter board on which the CPU is mounted) in connection with those CPUs on other daughter boards may be set as desired.

In a case where the technical scheme is applied to the image forming apparatus 1 shown in FIG. 2, circuit modules are respectively provided for the modules provided for optimizing individual products and for the system expansion. Further, it is arranged that the circuit module boards into which the technique (CPU 100+I/O part 200+devices) shown in FIG. 3A is incorporated may be increased or decreased in number. Additionally, the functional parts and the CPU 100 or the I/O part 200 are mounted on dedicated daughter boards. The daughter boards are detachably attached to a mother board on which devices as individual functional parts of the modules are mounted.

For example, as shown in FIG. 3B, connectors are provided on a mother board for the GUI 80 and the Sys part 85, a mother board for the IOT core part 20, a mother board for the feeder module 5, 6 and a mother board or the EXIT module 7. The connector of each mother board serves as an interface between the functional operation parts (devices), which operate corresponding to the functional parts dedicated to the circuit modules mounted on the mother boards.

The daughter board (CPU board) for the CPU 100 includes a circuit-attribute select controller part 150 and a connector as a board interface part, which is detachably attached to the connector on the mother board. Further, the daughter board (I/O board) for the I/O part 200 includes a connector as a board interface part, which is detachably attached to the connector on the mother board.

A function program of the CPU board is rewritten depending on which of those mother boards is selected to mount the CPU board thereon. A circuit on a mother board of those mother boards of the respective parts on which a CPU board set to the master by the circuit-attribute select controller part is mounted, is a main module circuit. A mother board on which the CPU board set to the slave is mounted is a slave module.

By so doing, common use of a software module containing the CPU 100 and the I/O part 200 is realized. Use of one kind of software module board suffices for the software module board PWB as a spare part (when the CPU 100 and I/O part 200 are respectively mounted on separate daughter boards, the same thing is true for each board). Further, what one has to do is to merely install (incorporate) a process software module suitable for each module into the CPU board by software updating. Additionally, by downloading a software into the FPGA, it is possible to change softwares (OS and application programs) and the I/O mapping of the same software module board. One kind of software module board may be used for any module or any portion of the module, and it may be varied in number. Thus, the image forming apparatus 1 having good system expansion is realized by employing the method in which the circuit board is replaceable with another one or varied in number.

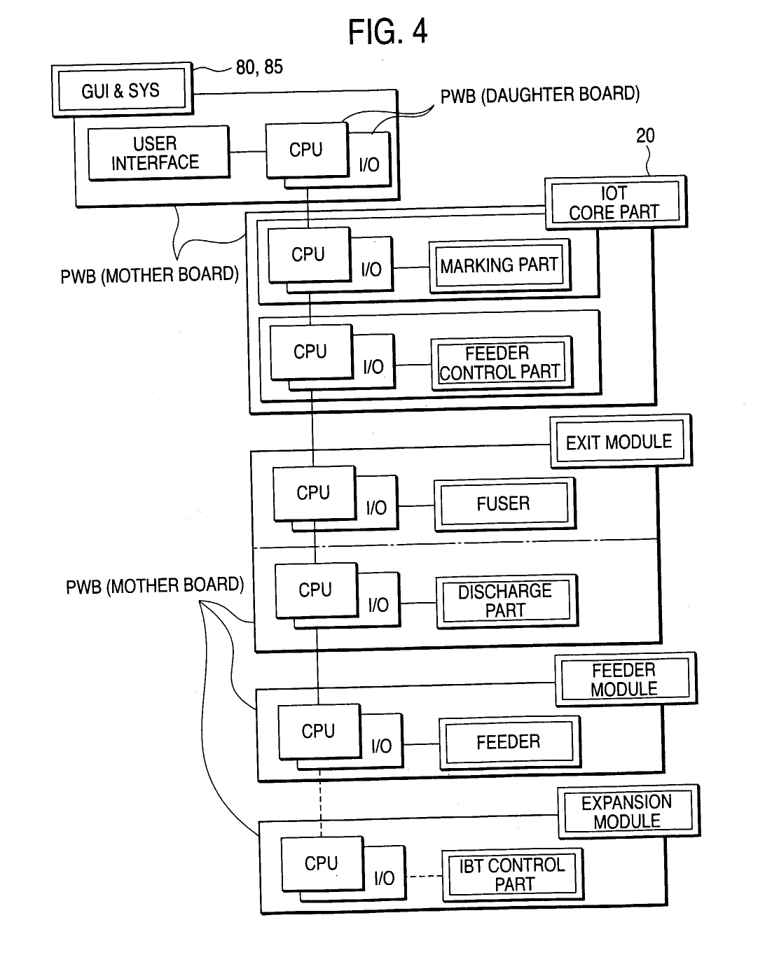

FIG. 4 is a diagram showing a specific configuration of an image forming apparatus 1 into which the technical scheme of FIGS. 2 and 3 is incorporated. The GUI and the SYS part are provided in the user interface 8, and daughter boards PWB for the user interface circuit, the 100 and the I/O part 200 is also provided therein.

The circuit of the IOT core part 20 is used as a main module circuit, and other module circuits are used as sub-module circuits. The IOT core part 20 includes a marking part MK concerning the printing process, daughter boards PWB for the CPU 100 for controlling the marking part and the I/O part 200, a feed control part PH for controlling the feeder modules 5 and 6, and daughter boards PWB for the CPU 100 for controlling the feed control part and the I/O part 200. The EXIT module 7 includes a fuser part for controlling the fuser, daughter boards PWB for the CPU 100 for controlling the fuser part and the I/O part 200, a discharge part (EXIT) for performing a sheet discharging process, and daughter boards PWB for the CPU 100 for controlling the discharge part and the I/O part 200. The feeder module 5, 6 includes each a feeder pat for driving a feed motor, and daughter boards PWB for the CPU 100 for controlling the feeder part and the I/O part 200. Further, a board for an expansion module is used as a spare board. The expansion module board includes an IBT control part adapted for the selection of an intermediate belt transfer (IBT) system, and daughter boards PWB for the CPU 100 for controlling the IBT control part and the I/O part 200.

As described above, in the image forming apparatus 1 of the instant embodiment appropriately satisfies the needs of high performance and high speed by the module division. Such a need is, for example, to change a 4-stage tandem construction to a tandem construction of 5 or more stages, or to change a processing speed to 200 or larger sheets per minute. In this case, the necessity frequently occurs to update softwares installed to the individual modules for the purpose of debugging or changing of module specifications. At this time, the problem presented to us is how to efficiently update the softwares.

The image forming apparatus 1 of the embodiment is module divided, and takes a substantially multi-CPU computer system. A mechanism to efficiently update the softwares is constructed by making use of fact that the CPUs operating under a common OS are used.

Accordingly, the specification change is easily made. In a case where a plurality of updating object modules are present, those modules are updated in a manner that individual programs are downloaded into one module collectively, and the updating operation of the remaining modules are controlled by using a “common rewriting program”, without feeding an updating program to the individual modules. This is an advantage resulting from the utilization of the CPUs incorporating the common OS. Specifically, the common OS (identical architecture) is used. Accordingly, a common rewriting program may be used, and other modules may be updated at one place.

In this case, it is judged which of the modules is the best to most efficiently download an updating program thereto. And the updating program and other updating programs are preferably downloaded into that module. The program rewriting work for plural modules may be performed in parallel by time division technique.

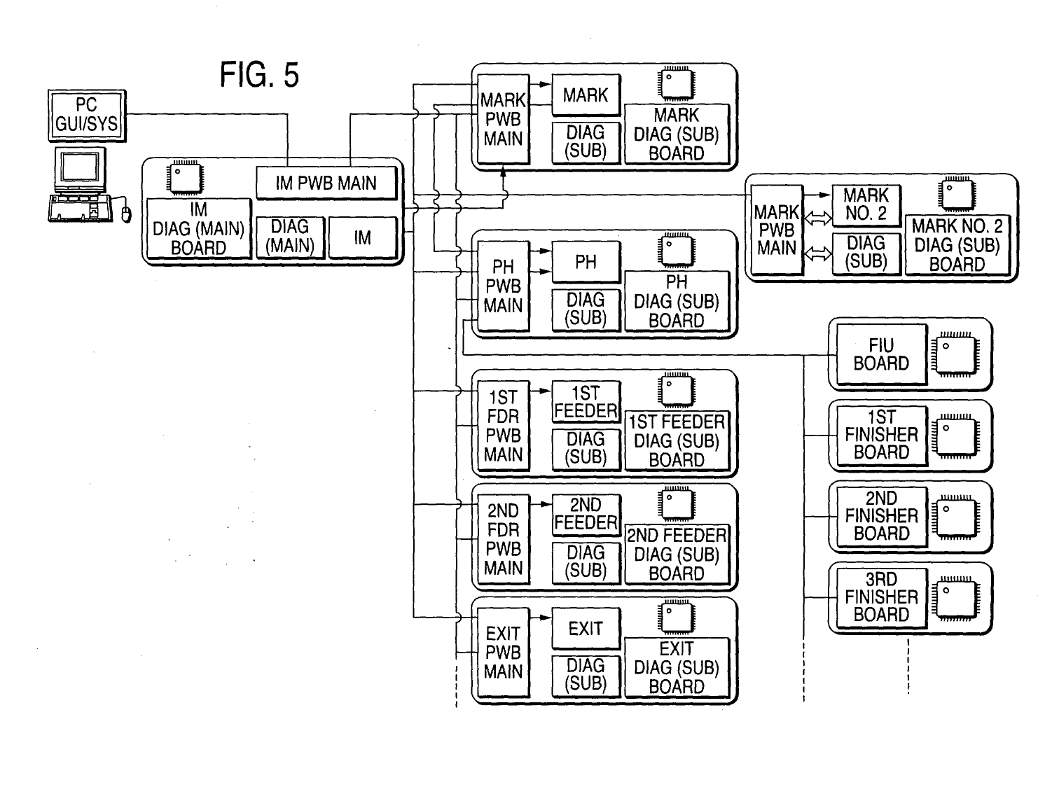

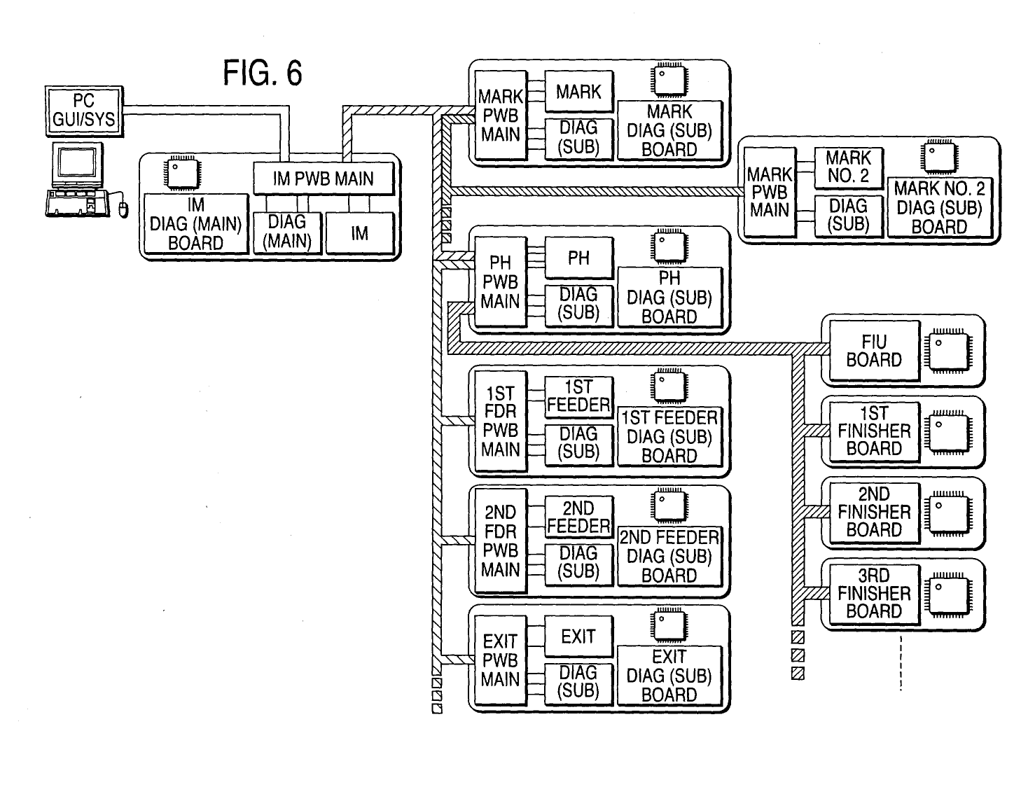

FIG. 5 is a diagram showing a connection configuration of a circuit module, which is depicted in light of a physical interface. FIG. 6 is a diagram showing a connection configuration of a circuit module, which is depicted in light of a logic interface. “FIU”, located on the right side of the drawing, indicates a finishing interface unit.

When an overall circuitry of the carriage I is constructed by combining circuit modules each constructed with the CPU 100 and the I/O part 200 as minimum constituent elements as shown in FIG. 4, circuit modules may be individually provided according to a module configuration of the apparatus or a plurality of circuit modules are combined into a single complex circuit module. When the CPUs 100 and the I/O parts 200 for the modules are disposed on a board, there is no need that the CPU 100 and the I/O part 200 for the same module are mounted on the same board. For example, the CPU 100 and the I/O part 200 for the IOT module 2 are disposed on different sub-boards, and those sub-boards are mounted on a mother board. Connection configurations of the physical interface and the logic interface of the circuit module vary depending on what combination is used.

The logic interface between the CPU 100 and the I/O part 200 for each module is preferably determined depending load conditions of the CPU 100 and the I/O part 200 or a module characteristic. Once the EXIT module 7 is set, it is rarely changed and it is substantially fixed. In the case of the finisher module, the specifications will frequently be changed according to use's desire. Bear this in mind in design. The image forming apparatus 1 contains a diagnosis system for diagnosing states of the respective parts in the apparatus, in addition to a data processing system. Also for the diagnosis processing system, it is preferable to construct a mechanism to flexibly cope with the module changes, for example, to distribute the load.

In an example of such, a supervising CPU for supervising the whole system and a supervising diagnosis part are provided. The supervising CPU receives a command from the user interface 8 and controls the individual CPUs (module CPUs) of the modules. In another example, the supervising CPU controls only major module CPUs, not all the module CPUs. Under the control, any of the module CPU controls the remaining module CPUs (sub-module CPUs). In this way, the load is distributed. Additionally, a change of the sub-module not containing the major CPU is prevented from affecting the supervising CPU.

FIGS. 5 and 6 illustrate the physical interface and the logic interface, by way of examples. Those interfaces were determined on the basis of the following points. It was intended to eliminate the influence by a configuration change of the board for the IOT module 2. To realize the IOT configuration having good system expansion, the instant embodiment employs the method of varying the number of the circuit boards. In this case, a mechanism is constructed to minimize the change of the software at that time, viz., to minimize a chance that a change of the interface occurs. By so doing, the software framing is promoted.

Further, to distribute the load, an TOT manager IM with a supervising CPU as an example of the master controller part is provided. A sub-CPU as an example of the slave control part, which operates responsive to an instruction from the supervising CPU (master control part), is provided in each of other modules. For example, the marking part MK (mark) concerning the printing process of the IOT module 2 is allotted to an image generation system, and the feed control part PH (paper handling) is allotted to the sheet transporting system (i.e., feeder module 5, second feeder module 6 and the like). The IOT manager IM supervises those. If so done, the finisher module will serve as the feed control part PH.

A diagnosis processing system (Diag) for diagnosing states of the respective parts in the apparatus consists of sub-diagnosis processor parts (Diag(Sub) for diagnosing states of functional parts allotted to the circuits of the boards in order to cope with the load distribution and module change, and a main diagnosis processor part (Diag (Main)) which is one form of a supervising diagnosis part for supervising statuses of the circuit board charge parts, which are obtained by the finisher processing part. By so doing, the main diagnosis processor part absorbs a change of the board configuration. A relation between the main diagnosis processor part and the sub-diagnosis processor parts is patterned and hence, the diagnosis processing system may be frameworked.

The diagnosis processing system monitors (analog monitors) analog quantities, such as read/write of the memory, initializing of the memory, I/O check, consumption articles, and sensor information, and does not monitor the presence/absence and operations of other modules of the scanner when the image forming apparatus is used for the copying machine. The diagnosis function of the finisher module is diagnosed by the finisher module per se. Accordingly, even if the finisher is changed, there is no need of changing the main diagnosis processor part. Further, the finisher may be used in an off-line state.

The system is arranged so that modules handled by the IOT manager IM are not changed. Accordingly, the IOT manager IM interfaces with only those parts; the marking part MK, the feed control part PH, the main diagnosis processor part, and the SYS part 85 of the user interface 8, for example. For the diagnosis processing system, a logic interface is employed between the main diagnosis processor part and the main module circuit. The IOT manager IM communication interfaces with the main diagnosis processor part, and does not interface with the sub-diagnosis processor part. Accordingly, if the board configuration on the diagnosis processing system is changed, there is no need of changing the IOT manager IM. As a result, an extraction degree of the IOT manager IM is increased and it may be frameworked.

The feed control part PH is so arranged such that if the feeder module 5 (6) is changed, the change does not affect the IOT manager IM, viz., the interface in the IOT is not changed. Accordingly, for example, the first feeder module (1stFdr) 5 and the second feeder module (2ndFdr) 6 are arranged to interface with only the feed control part PH. In this way, the IOT manager IM is frameworked. In this case, the sub-CPUs provided in the feed control part PH or the sub-module circuit containing the sub-CPUs and the I/O part sever as the sub-module circuits and the slave control parts in connection with the supervising CPU and the main module circuit containing the supervising CPU. Those serve as the master control part and the main module circuit in connection with the CPUs contained in the first feeder module 5 and the second feeder module 6.

The system is arranged such that even if the EXIT module 7 is changed, the change does not affect the IOT manager IM. To this end, the EXIT module 7 is arranged so as to interface with only the feed control part PH. If so done, the feed control part PH absorbs the change of the EXIT module 7. In this case, the sub-CPUs contained in the feed control part PH or the sub-module circuit containing the sub-CPUs and the I/O part sever as the sub-module circuits and the slave control parts in connection with the supervising CPU and the main module circuit containing the supervising CPU. Those serve as the master control part and the main module circuit in connection with the CPUs contained in the EXIT module 7.

In light of the logic interface, it is preferable to use the interface having on a communication protocol, which is suitable for harness cost reduction, improvement of a reliability of inter-module communication or increase of transmission speed. CAN (controller area network: ISO11898), for example, is suitable for this. Where a CAN bus based on the CAN is used, commands may simultaneously be sent. To reduce the load to the interface, the same interface is used for the feeder modules 5 and 6, and the EXIT module 7 by the utilization of the simultaneous command sending.

The system is arranged such that even if the configuration of the EXIT module 7 is changed, the change does not affect the interface of the finisher module or the interface load is reduced. To this end, the finisher module is controlled by the feed control part PH. If the finisher module is controlled by the EXIT module 7, information necessary for the finisher control must be sent by a route of IOT manager IM feed control part PH EXIT module 7, and hence the interface load is large. On the other hand, if the finisher, as described above, is controlled by the feed control part PH, the interface load is reduced.

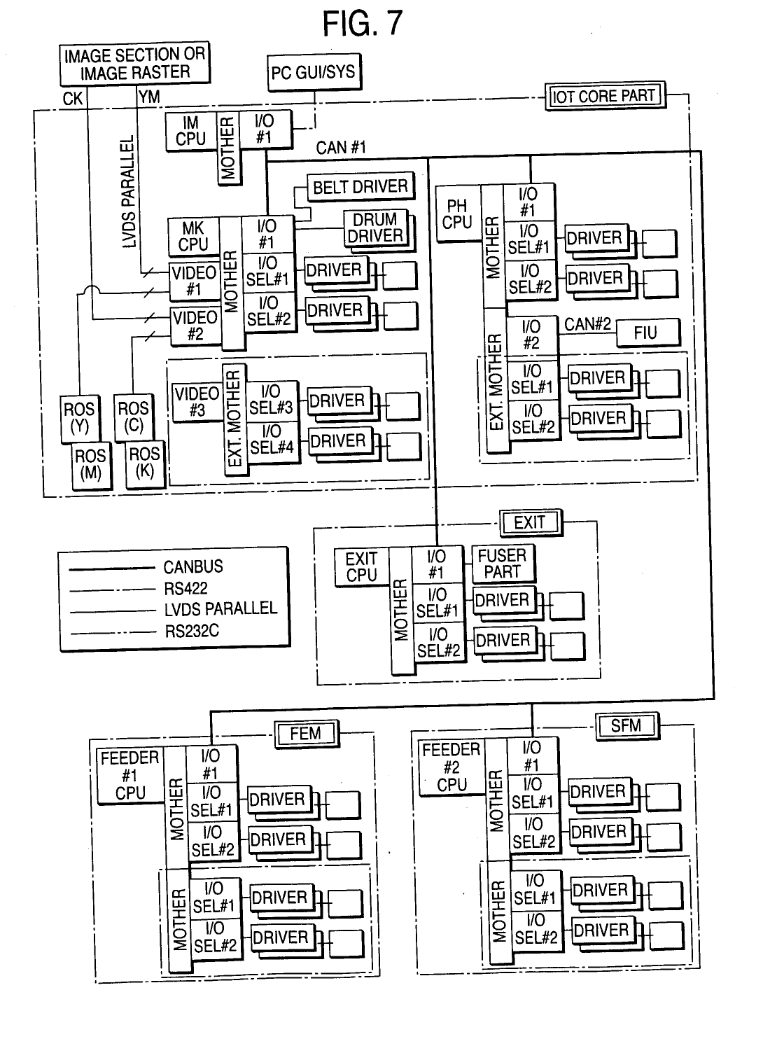

FIG. 7 is a diagram showing a configuration of a specific board interface when the connection configurations shown in FIGS. 4 to 6 are applied to the FIG. 2 image forming apparatus. In this embodiment, the circuit boards (daughter boards) for the respective circuit blocks are placed on the mother board.

A mother board for the IOT manager IM serving as the main module circuit, a mother board (MOTHER) for the marking part MK, and a mother board for the feed control part PH are contained in the IOT module 2. Similarly, the mother boards for the feeder modules 5 and 6 and the EXIT module 7 are contained in those modules.

Further, an additional mother board (Ext. MOTHER) is used so that an additional board is attached, for example, when the specifications are changed. To mount the finisher module, a board module is added corresponding to such.

Those mother boards may be a common mother board. Daughter boards, such as circuit boards proper to the modules, are connected onto the mother boards. Those circuit boards are, for example, an input/output board (I/O) for interface function between major circuit portions, such as IOT manager IM, marking part MK, feed control part PH, feeder part or output processor part, input/output select board (I/O SEL) for interface function to the drivers, CPU boards of the modules, or a video board (Video). A CAN bus is use for the logic interface between the modules.

Thus, the image forming apparatus employs a circuit architecture containing a plurality of function modules corresponding to the functional parts in the apparatus. Accordingly, to achieve the high speed, high performance, and multi-functions of the system, what one has to do is to merely replace the module board with a required one.

Any of the circuit modules contains the CPU (central processing unit) 100 on which a common operating system (OS) is installed and the I/O part 200. A function of the circuit module may be updated by rewriting an application software that the CPU 100 uses. A control mechanism by the CPU 100 is constructed with a common architecture into which the common operation system (OS) is installed. Accordingly, when the need of changing the specification arises, the specification can efficiently be changed. Particularly, when to change the specification, the objects whose programs are to be updated exist in a plurality of control systems, application programs may be efficiently and flexibly updated by utilizing the fact that common OS is installed on the objects, and the program rewriting mechanism.

The mother board may be connected to the daughter boards by using wire harness and connectors, not the board connectors. The bus transmission path for electric signal transmission between the CPU board and the video board, and the mother board or between the video board and the print engines (ROS) 30 may be constructed with an optical transmission member, such as a plastic optical fiber POF or a sheet-like optical transmission path (referred to as an optical sheet path).

Here, the optical sheet bus is such an optical transmission member that signal light is incident on an end face of a flat waveguide having a diffusion optical system, the signal light is diffused within the flat waveguide, and a plurality of signal lights are output from an end opposed to the former. Where the optical sheet bus is used, signal light is diffused at an end of the parallel plane and enters the flat waveguide, and the diffused signal light travels while repeating the total reflection between the upper an lower plates in the waveguide, and is transmitted to a number of light emitting parts opposed to the incident part.

Accordingly, the optical sheet path, unlike an application of the optical fiber, which is basically used for one-way communication of 1:1, has, for example, the following advantages:

1) A multi-cast transmission is possible in which transmissions of N:N are performed between a plurality of nodes at the opposed ends of the planer flat;

2) A bi-directional communication is possible in which communication is bi-directionally performed out between a plurality of node located at the opposed ends of the planer waveguide path; and

3) A multi-channel transmission is possible in which the transmission paths is made multiple bits by multi-layering the flat waveguides.

The core layer of the planer waveguide path may be formed with an optical resin sheet material of, for example, about 1 mm, such as PPMA (polymethyl methacrylate). Accordingly, the coupling of it to the light emitting/receiving element is easy. For the coupling, a passive alignment in which the alignment is carried out without driving the light emitting/receiving element is possible, not an active alignment in which related parts are mounted while monitoring an intensity of the optical signal, as is used in coupling the single mode optical fiber and the optical waveguide to the light emitting/receiving element. Use of the passive alignment enables simple mounting suitable for cost reduction and mass production.

Thus, the optical transmission member is used for the signal transmission interface between the boards. Accordingly, the wiring length is increased to be long while solving the EMI and EME problems, and problems caused by wave form deformation. Additionally, if the optical sheet bus is used, the transmission speed is increased and the number of nodes is increased.

If to increase the layout freedom by the board division, the board division is simply carried out, the number of signal lines for the interface is increased, thereby making the mounting difficult. A high speed signal travels through metallic wires (e.g., copper wires) to thereby cause the waveform deformation and EMI problems. On the other hand, where the transmission technique is utilized, even if the circuit board is set in the main body 83 of the user interface 8, the waveform deformation and EMI problems do not arise as described above. Particularly, if the optical sheet bus is used, the mounting problem and board layout restriction are lessened.

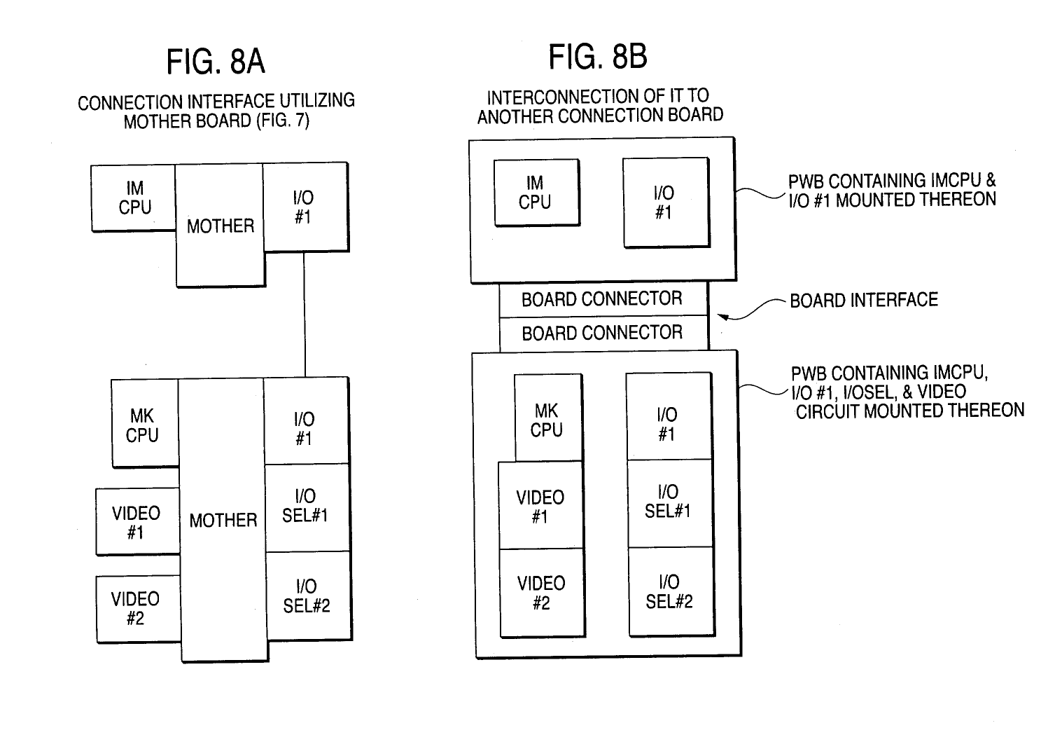

FIGS. 8A and 8B are diagrams for explaining another configuration of the board interface. In the instance shown in FIGS. 8A and 8B (part of it also shown in FIG. 8A), the circuit boards (daughter boards) for the circuit blocks are disposed on the mother board. If necessary, the board connectors are used as the board interface parts, and those boards are directly connected to each other.

As shown in FIG. 8B, the circuit board including the IMCPU and I/O #1 mounted thereon may be directly connected (physically and logically) to the circuit board including MKCPU, I/O#1, and I/O SEL, or the video circuit mounted thereon, by the board connectors. The same thing is true for the remaining modules.

While some specific embodiments have been described, it should be understood that the invention is not limited to those embodiments, but may variously be modified, altered and changed within the true spirits and scope of the invention.

It should also be understood that the invention is not limited to descriptions of appended claims, and that all the combinations of characteristic features discussed in the embodiment description are not always essential to the means to solve the problems. Further, the embodiments mentioned above includes the invention in various forms, and various forms of the invention will be extracted from appropriate combinations of constituent elements of the disclosed invention. It is to be understood that even if some constituent elements are removed from all of the constituent elements, the resultant technical idea defined by the remaining constituent elements will form the invention so long as the technical idea produces useful effects.

In the embodiments mentioned above, the IOT module 2 with the image forming portion and the EXIT module 7 with fuser 70 are removably put in different housings, respectively. A circuit architecture is constructed in which a main module containing a master control part for controlling the whole system and a plurality of sub-module circuits containing slave control parts controlled by the master control part are separately handled according to the respective functional parts in the apparatus body. However, in the circuit architecture, whether the IOT module 2 and the EXIT module 7 are removably put in different housings, respectively, is not essential to the invention.

For the application of the embodiment having been described about the circuit architecture, it is not limited to the xerography basis printing device (printer) including the image forming portion (print engines 30 in the above-mentioned embodiments) and the fuser 70, but it may be any device having a called printing function to form an image on the recording medium, such as a color copying machine and facsimile.

For example, the invention is applicable to an image forming apparatus which forms a visual image on a plain paper or heat-sensitive paper by an engine of the heat sensitive type, thermal transfer type, ink jet type or any of other conventional similar image forming mechanisms.

It is evident that the circuit architecture described in the embodiments mentioned above is applied not only to the device having the printing function, but also to general processing devices capable of executing given processes.

As seen from the foregoing description, the image forming part and the fuser part are removably put in different housings, respectively. Accordingly, the high speed, high performance or multi-functions of the system can be achieved by changing either of them.

A circuit architecture is constructed in which a main module circuit containing a master control part for controlling the whole system and a plurality of sub-module circuits containing slave control parts controlled by the master control part are separately handled according to the respective functional parts in the apparatus. To achieve the high speed, high performance or multi-functions of the system can be achieved by merely replacing a necessary module circuit board with another one. Accordingly, a good system expansion is secured.

With the feature that the main module containing a master control part and the plurality of sub-module circuits containing slave control parts are separately handled. Accordingly, the controls of the functional parts in each circuit module board may be unified in their handling, and the control system may be frameworked in accordance with the board module division. Therefore, even if a module around the IOT body is changed, a change required for the IOT body is minimized and the system expansion is improved.

What is claimed is:

1. An image forming apparatus for forming an image on a predetermined recording medium according to input image data and outputting the formed image, the apparatus comprising:
an image forming part for transferring the image onto a predetermined recording medium; and
a fuser part for fixing said transferred image on said recording medium are removably put in different housings, respectively.

2. The image forming apparatus according to claim 1, further comprising: an image forming control part for controlling said image forming part is disposed in said housing for said image forming part; and a fuser control part for controlling said fuser part is disposed in said housing for said fuser part.

3. An image forming apparatus which forms an image on a predetermined recording medium according to input image data, the apparatus comprising:
a plurality of functional module circuits corresponding to functional parts of said image forming apparatus,
wherein one of said functional module circuits includes a main module circuit containing a master control part for controlling individual circuits of said image forming apparatus, and the other of said functional module circuits includes sub-module circuits containing slave control parts which operated according to an instruction by said master control part.

4. The image forming apparatus according to claim 3 1, wherein said main module circuit and said sub-module circuits are controlled by a substantially common software architecture.

5. The image forming apparatus according to claim 3, wherein said main module circuit and said sub-module circuits are mounted on different circuit boards, and said circuit boards are removably mounted on a mother board for said circuit boards.

6. The image forming apparatus according to claim 4, wherein said main module circuit and said sub-module circuits each include an operating system part into which said software architecture is incorporated, and an interface part for interfacing with functional operation parts operating according to functional parts of said image forming apparatus, and are mounted on circuit boards removably mounted on a predetermined mother board.

7. The image forming apparatus according to claim 6, wherein said operating system part and said interface part are mounted on different circuit boards for each said functional module circuit, and said circuit boards are removably mounted on a mother board for said circuit boards.

8. The image forming apparatus according to claim 3, wherein said sub-module circuits each include a marking circuit for generating image data used for forming said image on a predetermined recording medium and a feeder control circuit for transporting said recording medium on which an image is to be formed according to said image data generated by said marking circuit, and said main module circuit controls said marking circuit and said feeder control circuit.

9. The image forming apparatus according to claim 3, wherein said sub-module circuits each include a sub-diagnosis processor part for diagnosing states of functional parts allotted to said sub-module circuits, and said main module circuit includes a supervising diagnosis part for supervising statuses of said circuit board charge parts, which are obtained by said sub-module circuits.

10. The image forming apparatus according to claim 9, wherein said supervising diagnosis part logically interfaces with said master control part of said main module circuit.

11. The image forming apparatus according to claim 3, wherein said master control part of said main module circuit logically interfaces with a controller for controlling the whole of said image forming apparatus.

12. The image forming apparatus according to claim 8, further comprising:
an image forming module for forming an image on said recording medium; and
a sheet feeder module for feeding said recording medium toward said image forming module, said module being removably put in different housings, and said sheet feeder module logically interfaces with said slave control part of said feeder control circuit.

13. The image forming apparatus according to claim 8, further comprising:
an image forming module for forming an image on said recording medium; and
a sheet discharge module for discharging said recording medium bearing said image formed by said image forming module, said module being removably put in different housings, and said sheet discharge module logically interfaces with said slave control part of said feeder-control circuit.

14. The image forming apparatus according to claim 8, further comprising:
an image forming module for forming an image on said recording medium; and
a finishing process module for finish-processing said recording medium bearing said image formed by said image forming module, said module being removably put in different housings, and said finishing process module logically interfaces with said slave control part of said feeder control circuit.

15. A circuit board used in any of image forming apparatuses defined in claim 3, said circuit board comprising:
a circuit-attribute select controller part for switching over an attribute of a circuit mounted on said circuit board to selecting a main module circuit or sub-module circuits; and
a board interface part being removably attached to a mother board mounted on said image forming apparatus.

16. A circuit board used in any of image forming apparatuses defined in claim 3, wherein said circuit board comprising:
a circuit-attribute select controller part for switching over an attribute of a circuit mounted on said circuit board to selecting a main module circuit or sub-module circuits; and
a board interface part being directly interconnected to another circuit board.

17. A circuit board used in any of image forming apparatuses defined in claim 15 or 16, said circuit board comprising:
an operating system part into which a software architecture is incorporated, said software architecture being substantially common in connection with said other circuit boards; and
an interface part for interfacing with functional operation parts operating according to functional parts of said image forming apparatus.

18. A circuit board used in any of image forming apparatuses defined in claim 15 or 16, said circuit board comprising an operating system part into which a software architecture is incorporated, said software architecture being substantially common in connection with said other circuit boards.

19. A circuit board used in any of image forming apparatuses defined in claim 15 or 16, said circuit board comprising an interface part for interfacing with functional operation parts operating according to functional parts of said image forming apparatus.
